(19) United States
(12) Patent Application Publication
(10) Pub. No.: US 2009/0179844 A1
(43) Pub. Date: Jul. 16, 2009

(54) DISPLAY ELEMENT, DISPLAY SYSTEM HAVING THE SAME, AND IMAGE PROCESSING METHOD

(75) Inventor: Masaki NOSE, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/409,071

(22) Filed: Mar. 23, 2009

Related U.S. Application Data
(63) Continuation of application No. PCT/JP2006/319252, filed on Sep. 28, 2006.

(51) Int. Cl. G09G 3/36; G02F 1/133

(52) U.S. Cl. 345/89; 349/72; 345/101

(57) ABSTRACT

The invention relates to a display element, a display system having the element, and an image processing method. There is provided a display element having high display quality, a display system having the element, and an image processing method utilizing the element. The display element includes a display section having a first display layer exhibiting a first spectrum and a second display layer formed on the first display layer and exhibiting a second spectrum shifted from the first spectrum toward longer wavelength, a temperature sensor for detecting a temperature in the vicinity of the display section, and a control section for generating display image data to be displayed by the first and second display layers based on input image data and the temperature such that the tint of a displayed color associated with the input image data is kept substantially constant without depending on the temperature.

This application is a continuation of International Application No. PCT/JP2006/319252, filed Sep. 28, 2006.

### BACKGROUND

1. Field

The present invention relates to a display element, a display system having the same, and an image processing method.

2. Description of the Related Art

Recently, various enterprises and universities are actively engaged in the development of electronic paper. Promising applications of electronic paper include electronic books first of all, and include mobile terminal sub-displays and display sections of IC cards. One of advantageous display methods used for electronic paper is the use of a liquid crystal display element utilizing a cholesteric liquid crystal. A liquid crystal display element utilizing a cholesteric liquid crystal has excellent characteristics such as semi-permanent display retention characteristics (memory characteristics), vivid color display characteristics, high contrast characteristics, and high resolution characteristics. A cholesteric liquid crystal is obtained by adding a relatively great amount (several tens percent) of chiral additive (chiral material) to a nematic liquid crystal, and it is also called a chiral nematic liquid crystal. A cholesteric liquid crystal forms a cholesteric phase in which molecules of the nematic liquid crystal are helically twisted with such a strength that incident light undergoes interference and reflection.

A display element utilizing a cholesteric liquid crystal is driven for display of an image by controlling the state of alignment of the liquid crystal molecules at each pixel. A cholesteric liquid crystal has two states of alignment, i.e., a planar state and a focal conic state. Those states exist with stability even when there is no electric field. A liquid crystal layer in the focal conic state transmits light, and a liquid crystal layer in the planar state selectively reflects light having a particular wavelength which is in accordance with the helical pitch of the liquid crystal molecules.

FIGS. 21A and 21B schematically show sectional configurations of a liquid crystal display element utilizing a cholesteric liquid crystal. FIG. 21A shows a sectional configuration of the liquid crystal display element in the planar state, and FIG. 21B shows a sectional configuration of the liquid crystal display element in the focal conic state. As shown in FIGS. 21A and 21B, a liquid crystal display element 146 includes a pair of substrates, i.e., substrates 147 and 149 and a liquid crystal layer 143 formed by enclosing a cholesteric liquid crystal between the substrates 147 and 149.

As shown in FIG. 21A, liquid crystal molecules 133 in the planar state form such a helical structure that helical axes are substantially perpendicular to substrate surfaces. In the planar state, the liquid crystal layer 143 selectively reflects light rays having a predetermined wavelength which is in accordance with the helical pitch of the liquid crystal molecules 133. Therefore, when the liquid crystal layer 143 is put in the planar state at a certain pixel, the pixel enters a bright state. A wavelength λ which results in the maximum reflection is given by an equation λ=n·p where n and p represent the average refractive index and the helical pitch of the liquid crystal, respectively. A reflection band width Δλ increases with reflective index anisotropy Δn of the liquid crystal.

As shown in FIG. 21B, in the focal conic state, the liquid crystal molecules 133 form such a helical structure that helical axes are substantially in parallel with the substrate surfaces. In the focal conic state, the liquid crystal layer 143 transmits most of incident rays of light. Therefore, when the liquid crystal layer 143 is put in the focal conic state at a certain pixel, the pixel enters a dark state. Black can be displayed in the focal conic state when a visual light absorbing layer is disposed on a bottom surface of the bottom substrate 149.

FIG. 22 schematically shows a sectional configuration of a common color liquid crystal display element utilizing a cholesteric liquid crystal. As shown in FIG. 22, the color liquid crystal display element has a structure in which a liquid crystal layer for displaying blue (B) (blue layer) 101B, a liquid crystal layer for displaying green (G) (green layer) 101G, and a liquid crystal layer for displaying red (R) (red layer) 101R are formed one over another in the order listed starting from a display surface side of the element (the top side of the element in the illustration). In general, a liquid crystal layer reflects light having a shorter wavelength, the higher the chiral material content of the layer. Specifically, in the case of the color liquid crystal display element shown in FIG. 22, the liquid crystal layer 101B includes the greatest amount of chiral material, and the layer therefore has a strong twist of the liquid crystal molecules and a short helical pitch. In general, a liquid crystal layer tends to require a higher driving voltage, the higher the chiral content of the layer.

FIG. 23 shows an example of reflection spectra of the liquid crystal display element. The abscissa axis of the figure represents wavelengths (nm), and the ordinate axis represents reflectances (%). The curve connecting the black triangular symbols represents a reflection spectrum at the liquid crystal layer 101B. The curve connecting the black square symbols represents a reflection spectrum at the liquid crystal layer 101G. The curve connecting the black rhombic symbols represents a reflection spectrum at the liquid crystal layer 101R. A liquid crystal layer in the planar state selectively reflects either of left-handed or right-handed circularly polarized rays of light. Therefore, the maximum reflectance of the layer has a theoretical value of 50% and an actual value of about 40%. As will be understood from above, the liquid crystal layers 101R, 101G, and 101B have different helical pitches of liquid crystal molecules to selectively reflect red, green, and blue, respectively. Thus, the liquid crystal display element formed by stacking the three liquid crystal layers 101R, 101G, and 101B is capable of color display.

However, in the case of a display element capable of color display having a multi-layer structure as described above, the tint of a displayed image can change depending on the environment of the element when the image is to be displayed with the same tint. Therefore, a display element having a multi-layer structure has a problem in that it cannot necessarily achieve high display quality.

### SUMMARY

According to aspects of an embodiment, there is display element including a display section having a first display layer exhibiting a first spectrum and a second display layer formed on the first display layer and exhibiting a second spectrum shifted from the first spectrum toward longer wavelength, a temperature detecting section for detecting a temperature in the vicinity of the display section, and a control section for generating display image data to be displayed by the first and second display layers based on input image data and the temperature such that the tint of a displayed color associated with the input image data is kept substantially constant without depending on the temperature.

The above invention is characterized in that the control section includes a lookup table and in that a correction coefficient for correcting the input image data based on the temperature to generate the display image data is stored in the lookup table.

The above invention is characterized in that the control section includes a lookup table and in that the input image data and the display image data associated with the temperature are stored in the lookup table.

The above invention is characterized in that the temperatures in the lookup table are divided into temperature ranges with a dividing width which becomes smaller, the lower the temperature of interest.

The above invention is characterized in that the control section generates the display image data by calculating a function using the input image data and the temperature.

The above invention is characterized in that the control section generates the display image data taking an overlapping region between the first and second spectra into account.

The above invention is characterized in that an electrical signal is applied to the display layers for a duration which is longer, the lower the temperature.

The above invention is characterized in that the duration of the application of the electrical signal is varied depending on the dividing width for the temperatures in the lookup table.

The above invention is characterized in that the display section includes a third display layer formed on the first and second display layers and exhibiting a third spectrum shifted from the first spectrum toward longer wavelength and shifted from the second spectrum toward shorter wavelength and in that the first, second, and third display layers display blue, red, and green, respectively.

The above invention is characterized in that the first, third, and second display layers are formed one over another in the order listed from the side of a display surface of the element.

The above invention is characterized in that the first, second, and third display layers have memory characteristics.

The above invention is characterized in that the first, second, and third display layers include a liquid crystal which forms a cholesteric phase.

The above invention is characterized in that color tints originating from the first, second, and third spectra include a color tint which becomes stronger depending on temperature and in that the display image data are generated by the control section such that a display grayscale values corresponding to the color tint becomes relatively smaller than display grayscale values corresponding to the other color tints.

The above invention is characterized in that the light rotating direction of the third display layer is different from the light rotating direction of the first and second display layers.

The above-described object is achieved by an electronic terminal characterized in that it includes a display element according to the above invention.

The above-described object is achieved by a display system comprising a display element including a display section having a first display layer exhibiting a first spectrum and a second display layer formed on the first display layer and exhibiting a second spectrum shifted from the first spectrum toward longer wavelength, a temperature detecting section for detecting a temperature in the vicinity of the display section, and a transmitting/receiving section for transmitting information of the temperature and receiving display image data to be displayed by the first and second display layers, and a display information transmission apparatus including a transmitting/receiving section for receiving the information of the temperature from the display element and transmitting the display image data to the display element and a control section for generating the display image data based on input image data and the temperature such that the tint of a displayed color associated with the input image data is kept substantially constant without depending on the temperature.

The above-described object is achieved by an image processing method including the steps of detecting a temperature in the vicinity of a display section having a first display layer exhibiting a first spectrum and a second display layer formed on the first display layer and exhibiting a second spectrum shifted from the first spectrum toward longer wavelength, and generating display image data to be displayed by the first and second display layers based on input image data and the temperature such that the tint of a displayed color associated with the input image data is kept substantially constant without depending on the temperature.

The invention makes it possible to provide a display element having high display quality, a display system having the display element, and an image processing method employing the display element.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 shows examples of reflection spectra of a common liquid crystal display element utilizing a cholesteric liquid crystal;

FIG. 2 shows examples of reflection spectra of a common liquid crystal display element utilizing a cholesteric liquid crystal;

FIG. 3 shows examples of reflection spectra of a common liquid crystal display element utilizing a cholesteric liquid crystal;

FIG. 4 is a graph representing a relationship between temperatures and reflectances in a focal conic state observed in a common liquid crystal display element utilizing a cholesteric liquid crystal;

FIG. 5 shows reflection spectra of a certain liquid crystal display element in a planar state;

FIGS. 6A and 6B are graphs showing the principle of a first embodiment of the invention;

FIG. 7 schematically shows reflection spectra observed at R, G, and B layers;

FIGS. 8A and 8B illustrate an example of a correction method used in the first embodiment of the invention;

FIGS. 9A and 9B illustrate the example of a correction method used in the first embodiment of the invention;

FIGS. 10A and 10B illustrate another example of a correction method used in the first embodiment of the invention;

FIGS. 11A and 11B illustrate the other example of a correction method used in the first embodiment of the invention;

FIG. 12 is a block diagram showing a schematic configuration of a display element according to the first embodiment of the invention;

FIG. 13 is a sectional view schematically showing a configuration of the display element according to the first embodiment of the invention;

FIGS. 14A and 14B show an example of a data structure of correction coefficients stored in an image correction LUT;

FIGS. 15A and 15B show voltage waveforms applied to a signal electrode for one selection period;

FIGS. 16A and 16B show voltage waveforms applied to a scan electrode for one selection period;

FIGS. 17A and 17B show voltage waveforms applied to a liquid crystal layer at a pixel for one selection period;

FIG. 18 is a graph showing an example of voltage-reflectance characteristics of cholesteric liquid crystals;

FIG. 19 is an illustration showing a modification of the image correction LUT;

FIG. 20 is a block diagram showing a schematic configuration of a display system according to a second embodiment of the invention;

FIG. 21 is an illustration schematically showing a sectional configuration of a color liquid crystal display element utilizing a cholesteric liquid crystal;

FIG. 22 is an illustration schematically showing a sectional configuration of a color liquid crystal display element utilizing a cholesteric liquid crystal; and

FIG. 23 shows an example of reflection spectra of a liquid crystal display element having a multi-layer structure.

### DESCRIPTION OF EMBODIMENTS

### First Embodiment

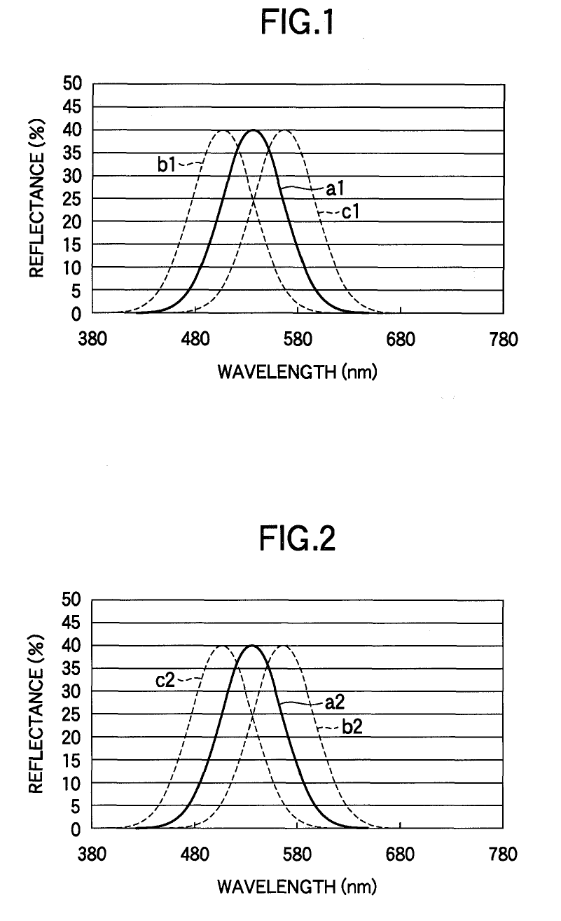

A display element and an image processing method according to a first embodiment of the invention will now be described with reference to FIGS. 1 to 19. First, a description will be made on problems of display elements according to the related art, the problems constituting a premise on which the embodiment has been conceived. Color liquid crystal display elements utilizing a cholesteric liquid crystal according to the related art have a problem in that selective reflection characteristics of a liquid crystal layer can change depending on temperature to cause a change in the tint (hue and chroma) of the color displayed by the layer. A first factor causing a change in the tint of the displayed color is a temperature-dependent shift of the wavelength reflected by the liquid crystal layer in the planar state. FIG. 1 shows examples of reflection spectra of a common liquid crystal display element utilizing a cholesteric liquid crystal in the planar state. The abscissa axis of the figure represents wavelengths (nm), and the ordinate axis represents reflectances (%). Curves a1, b1, and c1 represent reflection spectra observed on the same liquid crystal display element. The curve a1 represents a reflection spectrum observed at room temperature (which is, for example, 25° C.). The curve b1 represents a reflection spectrum observed at a temperature lower than the room temperature (for example, 0° C.). The curve c1 represents a reflection spectrum observed at a temperature higher than the room temperature (for example, 50° C.). FIG. 1 shows that the reflection spectrum of the liquid crystal display element is more greatly shifted toward shorter wavelengths the lower the temperature and that the spectrum is more greatly shifted toward longer wavelengths the higher the temperature.

FIG. 2 shows examples of reflection spectra of another liquid crystal display element utilizing a cholesteric liquid crystal in the planar state. The curve a2 represents a reflection spectrum observed at the room temperature. The curve b2 represents a reflection spectrum observed at a temperature lower then the room temperature. The curve c2 represents a reflection spectrum observed at a temperature higher than the room temperature. FIG. 2 shows that the reflection spectrum of the liquid crystal display element is more greatly shifted toward longer wavelengths the lower the temperature and that the spectrum is more greatly shifted toward shorter wavelengths the higher the temperature.

As apparent from above, the waveband of light selectively reflected in some cholesteric liquid crystal materials is more greatly shifted toward shorter wavelengths, the lower the temperature. Conversely, the waveband of light selectively reflected in some cholesteric liquid crystal materials is more greatly shifted toward longer wavelengths, the lower the temperature. A possible cause of such a wavelength shift is a change in the helical pitch p of the liquid crystal of interest.

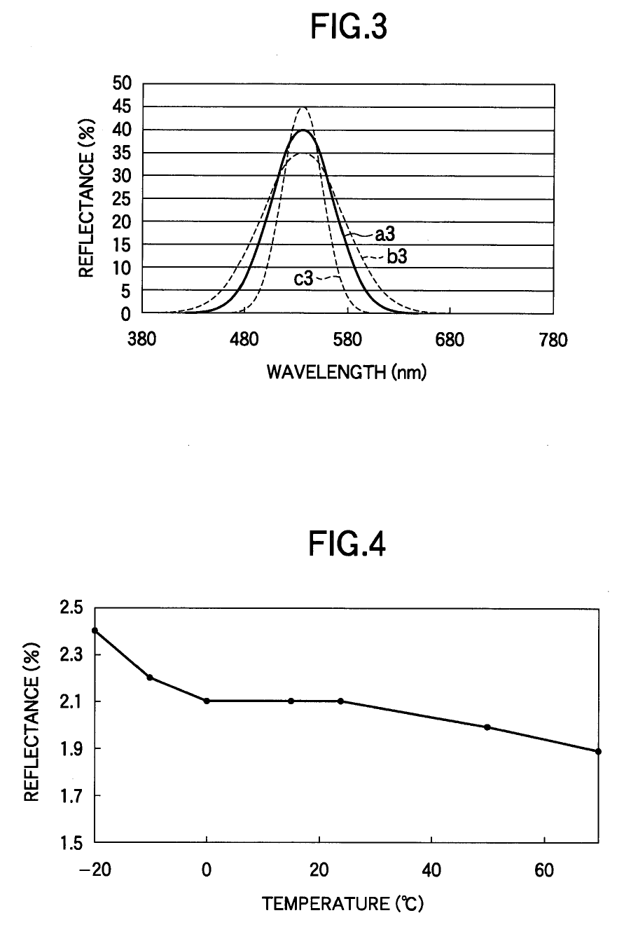

A second factor causing a change in the tint of a displayed color is a temperature-dependent change in a half width of a reflection spectrum of a liquid crystal display element utilizing a cholesteric liquid crystal. FIG. 3 shows examples of reflection spectra of a liquid crystal display element utilizing a cholesteric liquid crystal in the planar state. The curve a3 represents a reflection spectrum observed at the room temperature. The curve b3 represents a reflection spectrum observed at a temperature lower than the room temperature. The curve c3 represents a reflection spectrum observed at a temperature higher than the room temperature. As shown in FIG. 3, the half widths of the reflection spectra are greater, the lower the temperature. Thus, a liquid crystal display element utilizing a liquid crystal layer has color purity which is degraded as temperature decreases and is improved as temperature increases, in general. A possible cause of such a phenomenon is temperature-dependent changes in the refractive index anisotropy Δn of the liquid crystal. A temperature decrease results in an increase in the refractive index anisotropy Δn of the liquid crystal, and the half width of a reflection spectrum of the liquid crystal in the planar state consequently increases, which is supposed to be a cause of a reduction in color purity.

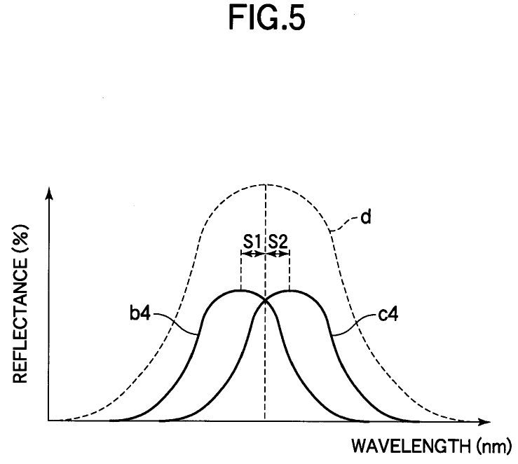

A change in refractive index anisotropy Δn also affects the focal conic state. When there is an increase in refractive index anisotropy Δn as a result of a temperature decrease, scattering of light in the focal conic state increases. FIG. 4 is a graph representing a relationship between temperatures and light reflectances of a liquid crystal layer in the focal conic state. The abscissa axis of the figure represents temperatures (° C.), and the ordinate axis represents reflectances (%). As shown in FIG. 4, scattering of light in the focal conic state is more significant and the layer therefore as a higher reflectance, the lower the temperature. Thus, in the case of a color liquid crystal display element having a structure formed by stacking, for example, liquid crystal layers for R, G, and B, light scattered in a liquid crystal layer in the focal conic state is superposed on light reflected by another liquid crystal layer in the planar state as a noise. Therefore such an element suffers from a more significant reduction in color purity at low temperatures.

JP-A-2001-100182 discloses a temperature compensation method for a liquid crystal layer in which compensation is performed by modulating a peak value or width of a drive pulse with reference to a Y-value indicating the brightness of the element such that the Y-value is kept constant regardless of temperature. However, the method has problems as described below. FIG. 5 shows reflection spectra of a certain liquid crystal display element in the planar state. The abscissa axis of the figure represents wavelengths (nm), and the ordinate axis represents reflectances (%). The curve b4 represents a reflection spectrum at a low temperature. The curve c4 represents a reflection spectrum at a high temperature. The curve d is a luminosity curve. As will be understood from FIG. 5, for example, the waveband reflected by a liquid crystal layer is shifted toward shorter wavelengths at low temperatures and shifted toward longer wavelength at high temperatures. Let us now assume that the amount of a shift S1 of the waveband from the center of the luminosity curve d toward shorter wavelengths occurring at a low temperature is equal to the amount of a shift S2 of the waveband from the center of the luminosity curve toward longer wavelengths occurring at a high temperature. Then, a Y-value obtained at the low temperature is substantially equal to a Y-value obtained at the high temperature. Although the Y-values are equal to each other, the displayed color will have different tints because the wavelengths are shifted in different directions at the low and high temperatures. Therefore, temperature compensation carried out with reference to the Y-values will not be successful in suppressing variation of the tint of the displayed color.

Methods for correcting a luminance value or white balance of a liquid crystal display element are known besides the above-described method.

JP-A-2001-238227 discloses a method of correcting white balance of a normally white mode transmissive liquid crystal display using a lookup table (LUT). However, variation of a color tint cannot be suppressed by the method which reflects no consideration to variation of gamma characteristics of a liquid crystal.

JP-A-2003-29294 discloses a liquid crystal display having a two-layer structure and utilizing a chiral nematic (cholesteric) liquid crystal. In the liquid crystal display, a peak wavelength selectively reflected by a liquid crystal layer reflecting rays having shorter wavelengths and a peak wavelength selectively reflected by a liquid crystal layer reflecting rays having longer wavelengths are shifted apart from each other as a result of a temperature rise. Thus, an image can be displayed with high brightness and high contrast regardless of the ambient temperature. However, when peak wavelengths selectively reflected by two liquid crystal layers are shifted as thus described, it is difficult to retain white balance and to suppress variation of a color tint.

JP-A-7-56545 discloses a method of correcting the white balance of a transmissive liquid crystal display using an LUT like JP-A-2001-238227. However, this method is also unsuccessful in suppressing variation of a color tint because no consideration is paid to temperature-dependent variation of gamma characteristics of a liquid crystal.

Japanese Patent No. 3299058 discloses a technique for correcting RGB image signals with reference to an LUT based on a temperature detected by a temperature sensor. However, according to the technique, RGB image signals are corrected based on the temperature of a lamp of a liquid crystal projector. Therefore, no consideration is paid to temporal and spatial differences between a detected temperature of the lamp and the actual temperature of the liquid crystal display element. Further, the technique relates to a transmissive liquid crystal projector, and the premise of the technique is therefore different from that of the invention.

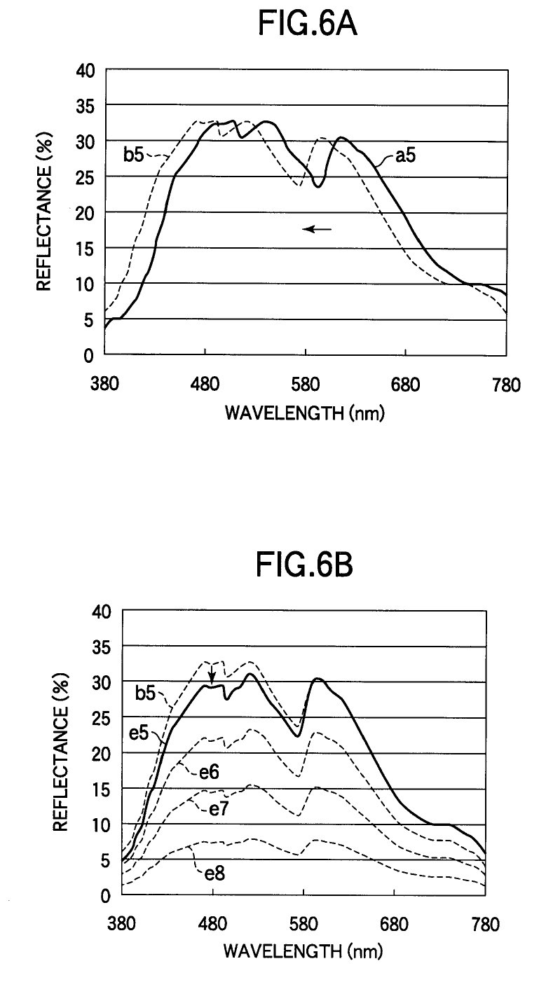

The inventor conceived a technique for solving the problem of a color display element having a multi-layer structure, i.e., variation of the tint of a displayed color caused by temperature. FIGS. 6A and 6B show a principle behind the present embodiment. FIG. 6A shows reflection spectra observed when grayscales are displayed by a color liquid crystal display element having a multi-layer structure formed by stacking three display layers, i.e., red, green, and blue layers. The curve a5 represents a reflection spectrum observed at the room temperature, and the curve b5 represents a reflection spectrum observed at a lower temperature. As shown in FIG. 6A, at the low temperature, the element has a reflection spectrum which is shifted as a whole toward shorter wavelengths (the direction of the wavelength shift is indicated by an arrow in FIG. 6A). Thus, gray balance is lost, and the grayscales as a whole are displayed with a bluish tint. That is, in this example, all of reflection spectra observed at the three display layers are shifted toward shorter wavelengths at the low temperature.

In the present embodiment, in order to suppress variation of the tint of a displayed color attributable to temperature as described above, input image data or a driving waveform is corrected based on correction information stored in an LUT. FIG. 6B shows reflection spectra observed at a low temperature before and after a correction is made. The curve b5 in FIG. 6B corresponds to the curve b5 in FIG. 6A and represents a reflection spectrum at the low temperature observed before the correction. The curve e5 represents a reflection spectrum observed after the correction. Each of the curves e6 to e8 represents a corrected reflection spectrum observed when lower grayscales are displayed. As shown in FIG. 6B, for example, reflectances on the short wavelength side are reduced within an appropriate range as indicated by an arrow in the figure based on correction information. Thus, the gray balance of the display is corrected to suppress variation of color tints. For example, grayscale value displayed by the display layer for displaying blue is decreased to reduce reflectances on the shorter wavelength side in the present embodiment.

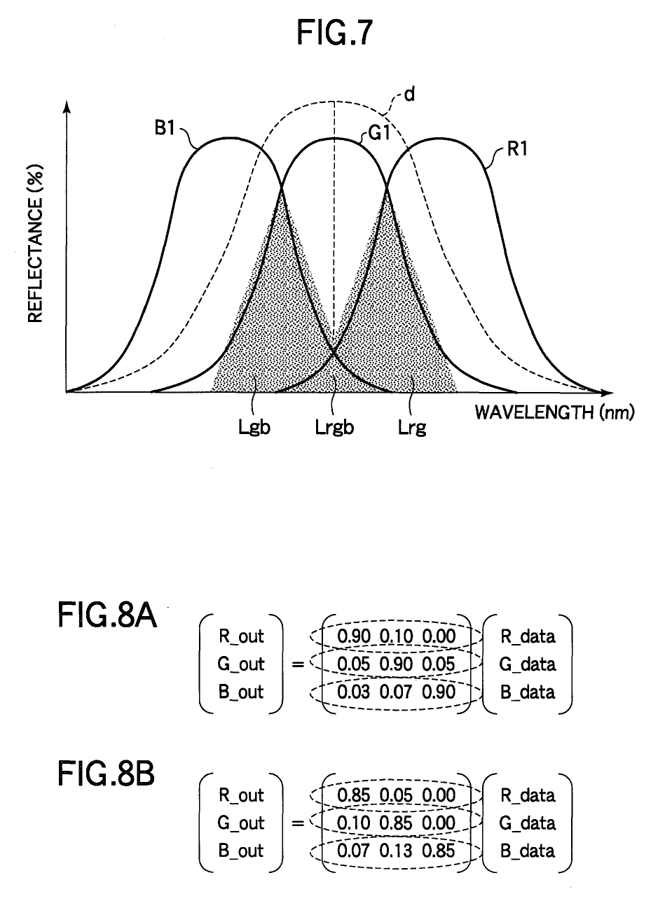

The correction information stored in the LUT includes information on mutual relationships between color information of the display layers formed one over another. Mutual relationships between the color information of the display layers will now be described. FIG. 7 schematically shows reflection spectra observed on the display layers for displaying red, green, and blue, respectively. The abscissa axis of the figure represents wavelengths (nm), and the ordinate axis represents reflectances (%). The curve R1 represents a reflection spectrum of the display layer for displaying red (R layer). The curve G1 represents a reflection spectrum of the display layer for displaying green (G layer). The curve B1 represents a reflection spectrum of the display layer for displaying blue (B layer). The curve d is a luminosity curve. When the reflection spectra of the R, G, and B layers are plotted one over another as shown in FIG. 7, the reflection spectra overlap each other in some regions. For example, the reflection spectrum of the R layer includes a region Lrg where the spectrum overlaps the reflection spectrum of the G layer and a region Lrgb where the spectrum overlaps the reflection spectra of the G and B layers. The presence of the overlapping regions Lrg and Lrgb indicates that light reflected by the R layer includes unnecessary green and blue color components. Similarly, the reflection spectrum of the G layer includes the region Lrg where the spectrum overlaps the reflection spectrum of the R layer, the region Lrgb where the spectrum overlaps the reflection spectra of the R and B layers, and a region Lgb where the spectrum overlaps the reflection spectrum of the B layer. Therefore, light reflected by the G layer includes unnecessary red and blue color components. The reflection spectrum of the B layer includes the region Lrgb where the spectrum overlaps the reflection spectra of the R and G layers and the region Lgb where the spectrum overlaps the reflection spectrum of the G layer. Therefore, light reflected by the B layer includes unnecessary red and green color components. Changes in the helical pitch p and the refractive index anisotropy Δn of the element attributable to temperature have influence on such unnecessary color components.

In the present embodiment, in addition to corrections made on the reflection spectra themselves to cope with changes in the helical pitch p and the refractive index anisotropy Δn attributable to temperature, corrections are made as occasion demands taking the overlapping regions between the reflection spectra of the R, G, and B layers into consideration.

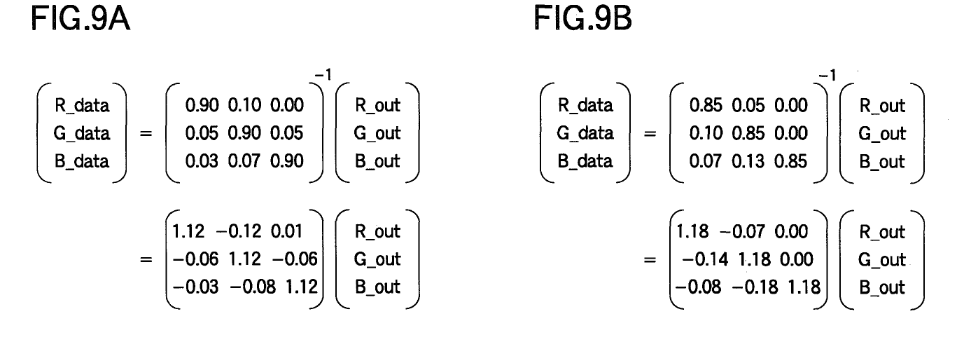

An example of a correction method used in the present embodiment will now be described. FIGS. 8A, 8B, 9A, and 9B illustrate the example of the correction method used in the present embodiment. First, correspondence between input image data and outputs actually displayed based on the input image data is determined in advance. FIG. 8A shows a relationship between input image data and outputs actually displayed based on the input image data at the room temperature, and FIG. 8B shows a relationship between input image data and outputs actually displayed based on the input image data at a lower temperature. RGB values of input image data are represented by (R_data, G_data, and B_data), and the tints of output colors actually displayed on a display screen are put in a form simulated from the input, i.e., RGB values (R_out, G_out, and B_out).

As shown in FIG. 8A, a relationship between the RGB values of the input image data and the RGB values, in a simulated form, of the outputs displayed on the display screen is expressed using a predetermined 3×3 matrix. For example, the red displayed on the display screen includes 90% components reflected by the R layer and 10% components reflected by the G layer. Similarly, the green displayed on the display screen includes 90% components reflected by the G layer, 5% components reflected by the B layer, and 5% components reflected by the R layer. The blue displayed on the display screen includes 90% components reflected by the B layer, 7% components reflected by the G layer, and 3% components reflected by the R layer. Each row of elements of the matrix (each row is enclosed in an ellipse in a broken line in FIG. 8A), i.e., each of an R row (first row), a G row (second row), and a B row (third row) has a total value of 1.

At the lower temperature, the reflection spectrum of each layer is shifted toward shorter wavelengths as a result of changes in physical characteristic values, and the ratios of the reflected components of each layer therefore change as shown in FIG. 8B. Each of the reflection spectra of the R layer and the G layer is shifted toward shorter wavelengths (toward a blue side). Then, for example, the percentage of the reflected components from the R layer included in the red displayed on the display screen decreases from 90% at the room temperature to 85%, and the percentage of the reflected components from the G layer decreases from 10% at the room temperature to 5%. The reflected components from the R layer included in the green displayed on the display screen increases in an amount according to the above-described shift, and the percentage of the components therefore increases from 5% at the room temperature to 10%. The percentage of the reflected components from the G layer included in the displayed green decreases from 90% at the room temperature to 85% because the reflection spectrum of the G layer is shifted toward the blue side. The percentage of the reflected components from the B layer included in the displayed green similarly decreases from 5% at the room temperature to 0%. The amount of the reflected components from the R layer included in the blue displayed on the display screen increases in an amount according to the above-described shift, and the percentage of the components therefore increases from 3% at the room temperature to 7%. The percentage of the reflected components from the G layer also increases from 7% at the room temperature to 13% because the amount of the components increases according to the above-described shift. The percentage of the reflected components from the B layer included in the displayed blue decreases from 90% at the room temperature to 85% because the reflection spectrum of the B layer is shifted toward ultraviolet.

The rows of elements of the matrix shown in FIG. 8B (each row is enclosed in an ellipse in FIG. 8B), i.e., R, G, and B rows have total values of 0.90, 0.95, and 1.05, respectively. Since the B row has the greatest total value, gray balance is distorted toward blue at the low temperature, and the output image as a whole is displayed with a bluish tint.

In order to correct such color imbalance at the room temperature, the inverse of the above-described 3×3 matrix obtained from the tendency of the reflection spectra may be conveniently used as a correction coefficient. Specifically, as shown in FIG. 9A, the product of the input image data (RGB values of color tints to be actually displayed on the display screen, i.e., (R_out, G_out, and B_out) and the inverse (correction matrix) of the matrix shown in FIG. 8A is obtained. Thus, the input image data is corrected to obtain display image data (R_data, G_data, and B_data) to be output to a display unit. Writing is performed based on the display image data thus obtained, whereby unclearness of colors attributable to overlapping reflection spectra can be corrected to high display quality.

In order to correct a bluish tint that appears at the low temperature, as shown in FIG. 9B, the product of the input image data (R_out, G_out, B_out) and the inverse (correction matrix) of the 3×3 matrix shown in FIG. 8B is obtained. Thus, display image data (R_data, G_data, B_data) to be output to the display unit is obtained. The rows of elements of the correction matrix shown in FIG. 9B, i.e., R, G, and B rows have total values of 1.11, 1.04, and 0.92, respectively. As will be apparent from above, since the B row has the smallest total value, a correction is made to decrease the values of the grayscales displayed by the B layer, and a distortion of gray balance toward blue at the low temperature is suppressed. Writing is carried out based on the display image data, whereby a distortion of gray balance attributable to a wavelength shift can be suppressed to achieve high image quality.

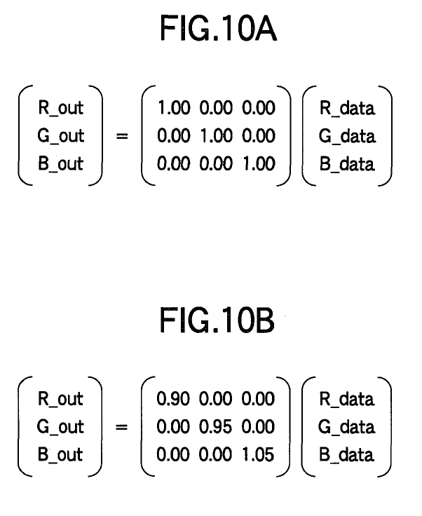

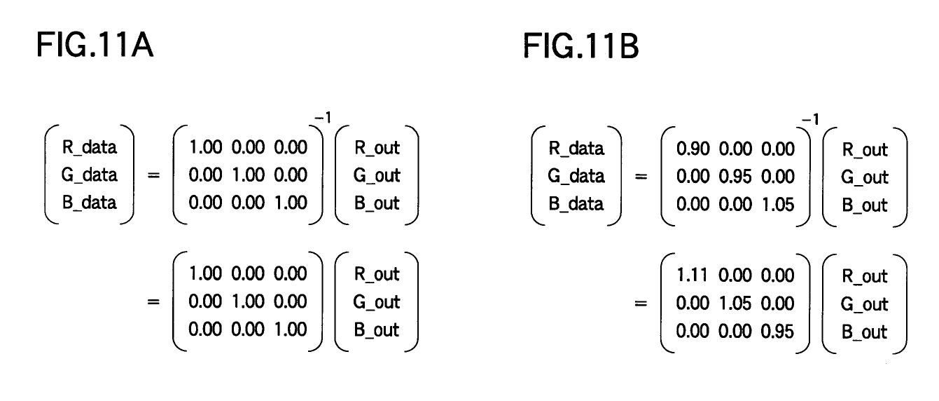

A brief description will now be made on another example of a correction method used in the present embodiment, in which overlapping regions between reflection spectra of R, G, and B layer are not taken into account. FIGS. 10A, 10B, 11A, and 11B illustrate the example of the correction method used in the present embodiment. First, correspondence between input image data and outputs actually displayed based on the input image data is determined in advance. FIG. 10A shows a relationship between input image data and outputs actually displayed based on the input image data at the room temperature, and FIG. 10B shows a relationship between input image data and outputs actually displayed based on the input image data at a lower temperature.

As shown in FIG. 10A, this example is based on an assumption that components reflected from an R layer constitute 100% of a red displayed on a display screen at the room temperature. Similarly, it is assumed that components reflected from a G layer constitute 100% of a green displayed on the display screen and that components reflected from a B layer constitute 100% of a blue that is displayed. At the room temperature, each row of elements of the matrix, i.e., each of R, G, and B rows has total value of 1.

At the lower temperature, as shown in FIG. 10B, the rows of elements of the matrix, i.e., the R, G, and B rows have total values of 0.90, 0.95, and 1.05, respectively. That is, since the B row has the greatest total value, gray balance is distorted toward blue, and the output image as a whole is displayed with a bluish tint at the low temperature.

As shown in FIG. 11A, the product of input image data (R_out, G_out, B_out) and the inverse of the matrix shown in FIG. 10A is obtained. Thus, display image data (R_data, G_data, B_data) to be output to a display unit are obtained. In this example, since the 3×3 matrix is an identity matrix, the inverse matrix is identical to the original matrix. Therefore, substantially no correction is made to the input image data at the room temperature in this example.

At the lower temperature, as shown in FIG. 11B, the product of the input image data (R_out, G_out, B_out) and the inverse (correction matrix) of the matrix shown in FIG. 10B is obtained. Thus, display image data (R_data, G_data, B_data) to be output to the display unit are obtained. The rows of elements of the correction matrix shown in FIG. 11B, i.e., R, G, and B rows have total values of 1.11, 1.05, and 0.95, respectively. It will be understood that since the B row has the smallest total value, a distortion of gray balance toward blue is corrected. In this example, however, relationships between different display layers are not taken into account. As a result, a color is more likely to be over-corrected, and the accuracy of correction will not be so high.

Although two exemplary methods of obtaining a correction coefficient for color correction have been described above, the two examples constitute no limitation on methods of correction to be used in the present embodiment. In the present embodiment, various methods of correction may be used to make a correction to cope with a wavelength shift in the planar state attributable to temperature and variation of refractive index anisotropy Δn attributable to temperature. When a correction is made for a display layer, it is desirable to take relationships with other display layers into consideration.

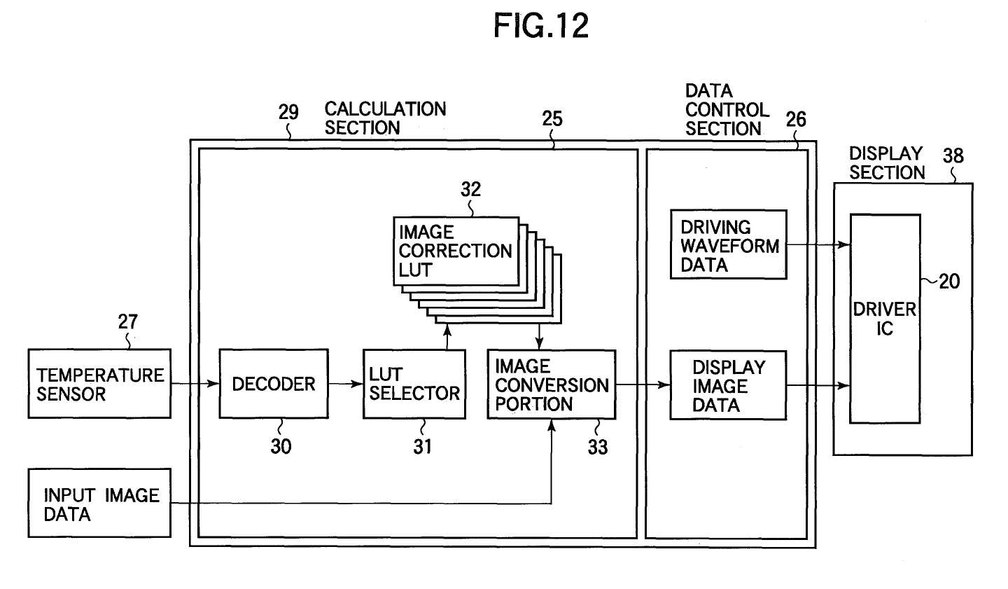

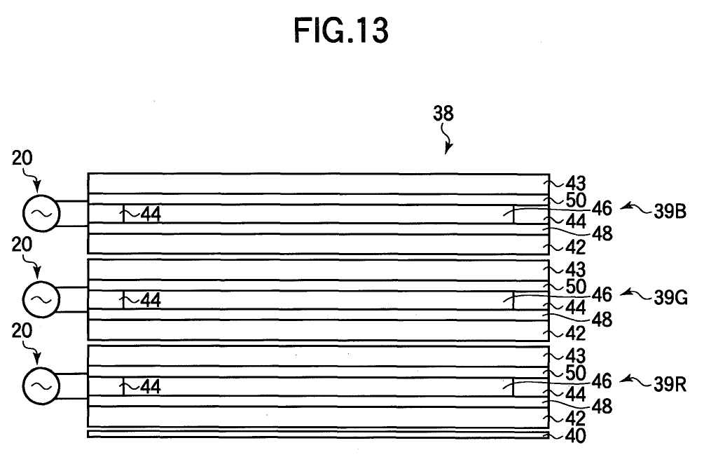

A display element, electronic paper, and an image processing method according to the present embodiment will now be described. FIG. 12 is a block diagram showing a schematic configuration of a display element according to the present embodiment. FIG. 13 is a sectional view schematically showing a configuration of the display element of the present embodiment. As shown in FIGS. 12 and 13, the display element (liquid crystal display element) includes a display section 38 having memory characteristics. The display section 38 has a configuration in which a display layer 39B for displaying blue, a display layer 39G for displaying green, and a display layer 39R for displaying red are formed one over another in the order listed from the side of the section where a display surface is provided (the top side of FIG. 13). Further, a visible light absorbing layer 40 is provided on a bottom surface of the display layer 39R (the bottom side of FIG. 13) as occasion demands.

Each of the display layers 39R, 39G, and 39B has a pair of substrates 42 and 43 which are combined with each other with a seal material 44 interposed between them. For example, both of the glass substrates 42 and 43 have translucency to allow visible light to pass. Glass substrates or film substrates having high flexibility made of polyethylene terephthalate (PET), polycarbonate (PC) or the like may be used as the substrates 42 and 43.

A plurality of scanning electrodes 48 in the form of strips extending substantially in parallel with each other are formed on a surface of the substrate 42 facing the substrate 43. A plurality of signal electrodes 50 in the form of strips extending substantially in parallel with each other are formed on a surface of the substrate 43 facing the substrate 42. When the display layer is of the Q-VGA type, for example, 240 scanning electrodes 48 and 320 signal electrodes 50 are formed. The scanning electrodes 48 and the signal electrodes 50 extend to intersect each other in a view of the same taken perpendicularly to substrate surfaces. A plurality of regions where the scanning electrodes 48 and the signal electrodes 50 intersect each other constitute pixel regions in a matrix-like disposition. The scanning electrodes 48 and the signal electrodes 50 are formed using, for example, an indium tin oxide (ITO). The scanning electrodes 48 and the signal electrodes 50 may alternatively be formed using transparent conductive films made of an indium zinc oxide (IZO) or the like. Still alternatively, the scanning electrodes 48 and the signal electrodes 50 may be formed from amorphous silicon or the like.

The scanning electrodes 48 and the signal electrodes 50 are preferably coated with insulating thin films or alignment stabilizing films. The insulating thin films have the function of improving the reliability of the liquid crystal display layer by preventing shorting between the electrodes and serving as gas barrier layers to block gas components. Organic films made of a polyimide resin, an acryl resin or the like are preferably used as the alignment stabilizing films. In this example, the scanning electrodes 48 and the signal electrodes 50 are coated with alignment stabilizing films (not shown). The alignment stabilizing films may also serve as the insulating thin films.

Spacers (not shown) for maintaining a uniform cell gap are provided between the glass substrates 42 and 43. The spacers may be spherical spacers made of a resin or an inorganic oxide, fixed spacers coated with a thermoplastic resin on the surface thereof, or columnar or wall-like spacers formed on the substrates using a photolithographic process.

A cholesteric liquid crystal composition exhibiting a cholesteric phase at room temperature is enclosed between the glass substrates 42 and 43 to form a liquid crystal layer (display layer) 46. The cholesteric liquid crystal composition is made by adding 10 to 40 wt % chiral material to a nematic liquid crystal mixture. The amount of chiral material added is a value on an assumption that the total amount of the nematic liquid crystal and the chiral material corresponds to 100 wt %. When the amount of chiral material added is large, the molecules of the nematic liquid crystal are strongly twisted. Thus, the helical pitch becomes small, and light having short wavelengths is selectively reflected in the planar state. Conversely, when the amount of chiral material added is small, the helical pitch becomes great, and light having long wavelengths is selectively reflected in the planar state. The liquid crystal layer 46 constituting the display layer 39R selectively reflects light having wavelengths of red in the planar state. Another liquid crystal layer 46 constituting the display layer 39G selectively reflects light having wavelengths of green in the planar state. Still another liquid crystal layer 46 constituting the display layer 39B selectively reflects light having wavelengths of blue in the planar state.

The direction of a temperature-dependent wavelength shift of a liquid crystal depends on the chiral material used. For example, some chiral materials cause a selectively reflected wavelength to be shifted toward longer wavelengths when there is a temperature rise, and some chiral materials cause a selectively reflected wavelength to be shifted toward shorter wavelengths when there is a temperature rise. Although a wavelength shift can be suppressed to some degree by mixing chiral materials causing wavelength shifts in opposite directions, it is difficult to suppress a wavelength shift completely. For example, in the case of a display element having a multi-layer structure formed by three layers, i.e., R, G, and B layers, it is preferable to arrange the liquid crystal layers such that wavelength shifts occur in the same direction because the amount of a correction as described above can be made small.

Various known materials may be used as the nematic liquid crystal. The cholesteric liquid crystal composition preferably has dielectric constant anisotropy Δ∈ in the range from 20 to 50. When the dielectric constant anisotropy Δ∈ is 20 or more, any significant increase in a driving voltage can be avoided. Therefore, inexpensive general-purpose components can be used in a driving circuit. When the dielectric constant isotropy Δ∈ of the cholesteric liquid crystal composition is too much lower than the above-described range, an undesirably high driving voltage will be required.

Conversely, when the dielectric constant anisotropy Δ∈ of the cholesteric liquid crystal composition is too much higher than the above-described range, the display element will have low stability and reliability, and image defects and image noises will be more likely to occur.

The refractive index anisotropy Δn of the cholesteric liquid crystal composition is an important physical characteristic value which dominates image quality. It is preferable that the refractive index anisotropy Δn is substantially in the range from 0.18 to 0.24. When the refractive index anisotropy Δn is smaller than the range, the composition has low reflectance in the planar state which results in low display luminance. When the refractive index anisotropy Δn is greater than the range conversely, significant scattering of light occurs in the focal conic state to reduce color purity and contrast, and a displayed image will be blurred. It is desirable that the cholesteric liquid crystal composition has a specific resistance in the range from 10¹⁰ to 10¹³ Ω·cm. A voltage increase and a reduction of contrast at a low temperature can be more effectively suppressed, the lower the viscosity of the cholesteric liquid crystal composition. It is desirable that the cholesteric liquid crystal composition has viscosity in the range from 20 to 1200 mPa·s from the point of view of response speed and stability of alignment.

In the present embodiment, the optical rotatory power (light rotating direction) of the liquid crystal layer 46 constituting the display layer 39G in the planar state is different from the optical rotatory power of the liquid crystal layers 46 constituting the display layers 39R and 39B. Therefore, in a region where reflection spectra of blue and green overlap and a region where reflection spectra of green and red overlap as shown in FIG. 7, right-handed circularly polarized light can be reflected by the liquid crystal layer 46 constituting the display layers 39B and 39R, and left-handed circularly polarized light can be reflected by the liquid crystal layer 46 constituting the display layer 39G. As a result, loss of reflected light can be reduced to improve the brightness of the display screen of the liquid crystal display element.

The liquid crystal display element also includes a driver IC on a scan side and a driver IC on a data side each of which is connected to a display section 38 in the same manner as in the STN mode liquid crystal display element (the ICs are represented by one driver IC 20 in FIG. 12). In the present embodiment, general-purpose STN drivers are used as the driver ICs. In a liquid crystal display element like the present embodiment in which a plurality of display layers 39R, 39G, and 39B are formed one over another, in general, a data-side driver IC must be independently provided in each layer. On the contrary, a common scan-side driver IC may be shared between the layers.

The liquid crystal display element further includes a power supply section which is not shown. For example, the power supply section includes a DC-DC converter which boosts a voltage of, for example, 3 to 5 Vdc input from outside to a voltage of about 30 to 40 Vdc required to drive the cholesteric liquid crystal. The power supply section generates a plurality of levels of voltage using the boosted voltage, according to the grayscale value at each pixel and depending on whether each pixel is selected or not. The generated voltages are stabilized by a regulator including a Zener diode and an operational amplifier and are supplied to the driver ICs 20.

The liquid crystal display element also includes a temperature sensor (temperature detecting section) 27 provided, for example, in the vicinity of the display section 38. The temperature sensor 27 detects the temperature in the vicinity of the display section 38 and outputs temperature data based on the detected temperature.

Further, the liquid crystal display element has a control section 29 including a calculation portion 25 and a data control portion 26. The calculation portion 25 receives input image data input from outside and the temperature date in the vicinity of the display section 38 input from the temperature sensor 27. Temperature data may alternatively input to the calculation portion 25 from outside. In this case, there is no need for providing the temperature sensor 27 in the liquid crystal display element. Based on the input image data and temperature data, the calculation portion 25 generates display image data to be displayed by the display layers 39R, 39G, and 39B and outputs the data to the data control portion 26.

An output value from the temperature sensor 27 is input to a decoder 30 in the calculation portion 25. The decoder 30 converts the output value from the temperature sensor 27 into temperature data in a predetermined form and outputs the data to an LUT selector 31. When the output of the temperature sensor 27 is a digital signal, the decoder 30 encodes it in accordance with the LUT selector. When the output of the temperature sensor 27 is an analog signal, the decoder 30 is provided with the function of an A-D converter. Based on the temperature data input from the decoder 30, the LUT selector 31 selects an optimal correction coefficient from an image correction LUT 32 in which correction coefficients associated with temperatures in the vicinity of the display section 38 are stored.

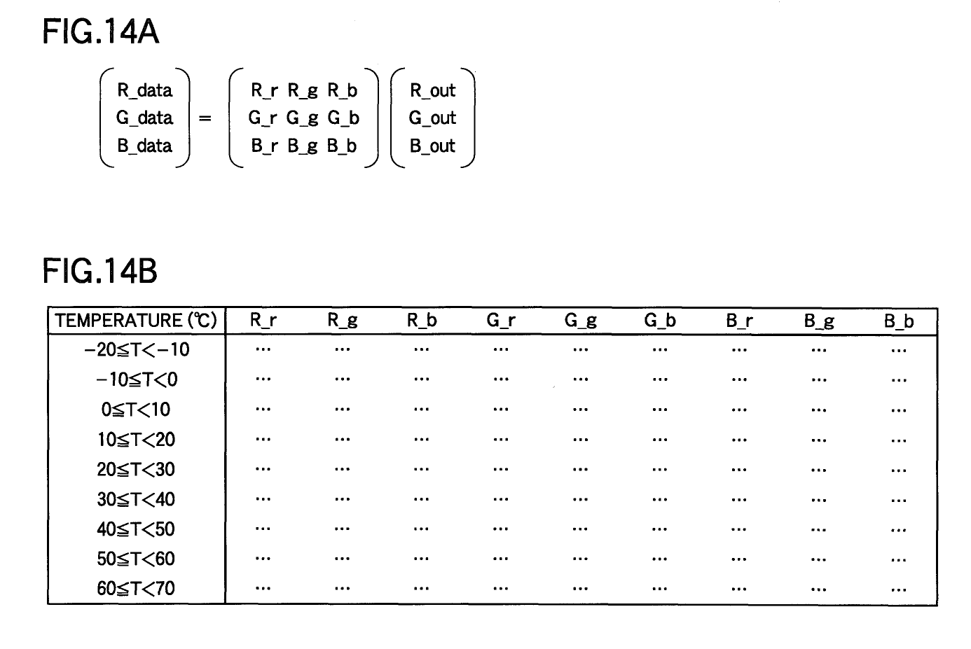

FIGS. 14A and 14B show an example of a data structure of the correction coefficients stored in the image correction LUT 32. As shown in FIG. 14A, elements in a first row of a correction matrix in the form of a 3×3 matrix are R_r, R_g, and R_b. Elements in a second row of the matrix are G_r, G_g, and G_b. Elements in a third row of the matrix are B_r, B_g, and B_b. In this case, as shown in FIG. 14B, the elements R_r, R_g, R_b, G_r, G_g, G_b, B_r, B_g, and B_b of the correction matrix are stored in the image correction LUT 32 as correction coefficients for predetermined respective temperature ranges. In this example, temperatures T between a lowest temperature of −20° C. and a highest temperature of 70° C., inclusive, are divided into nine temperature ranges each having a width of 10° C. The accuracy of correction is improved when the temperatures T are divided with a smaller width. In this case, however, the amount of data is increased. Therefore, the dividing width for the temperatures T is desirably about 5° C. and may alternatively be about 10° C. as in the present example. As is apparent from temperature dependency of light reflectance (refractive index anisotropy) of a liquid crystal layer in the focal conic state shown in FIG. 4, physical characteristic values of a liquid crystal undergo more abrupt changes, the lower the temperature thereof. Therefore, in order to achieve higher correction accuracy, it is preferable to make the dividing width smaller, the lower the temperatures T of interest.

Referring to FIG. 12 again, the input image data from outside are input to an image conversion part 33 of the calculation portion 25. The image conversion part 33 performs a calculation process based on the input image data and the correction coefficient selected by the LUT selector 31 to generate display image data to be displayed by the display layers 39R, 39G, and 39B. The image conversion part 33 may generate the display image data through a predetermined function calculating process using the input image data and temperature data rather than generating the display image data based on the correction coefficient. In this case, although the display image data are generated at a lower speed, the calculation portion 25 requires a smaller memory capacity because the image correction LUT 32 is not required.

It is a general understanding that a display element having memory characteristics generates new display image data when a display rewrite is performed to make a change in displayed contents. In the present embodiment, however, when a temperature change having a certain magnitude is detected, new display image data may be generated to perform a display rewrite even if there is no change in displayed contents. Alternatively, temperatures may be detected periodically, and display image data may be periodically generated to perform a display rewrite based on the temperatures even when there is no change in displayed contents.

A gray level conversion process is performed on the display image data thus generated as occasion demands. For example, when the display section 38 displays 4096 colors, each of the display layers 39R, 39G, and 39B can display 16 gray levels. When the input image data are full color data (all of red, green, and blue have 256 gray levels (8 bits)), a gray level conversion process must be performed according to the number of gray levels that can be displayed. Referring to algorithm for the gray level conversion, while the dot method and the systematic dither method may be used, the error diffusion method is preferable in that it provides high resolution and sharpness of images and matches a liquid crystal display element utilizing a cholesteric liquid crystal well. The next advantageous method is the blue noise mask method. The blue noise mask method is advantageous in that it allows high speed processing, although the method provides image quality somewhat lower than that achievable with the error diffusion method.

The display image data generated by the image conversion part 33 are output to the data control portion 26. The data control portion 26 generates drive data based on display image data for each of the display layers 39R, 39G, and 39B input from the image conversion part 33 and, for example, preset driving waveform data. The data control portion 26 outputs the drive data thus generated to the data side driver IC 20 in accordance with a data fetching clock. The data control portion 26 also outputs a pulse polarity control signal, a frame start signal, and control signals for data latching and scan shifting to the data side and scan side driver ICs 20.

Although not shown, electronic paper according to the present embodiment is configured by providing a liquid crystal display element as described above with an input/output device and a controller for controlling the electronic paper as a whole.

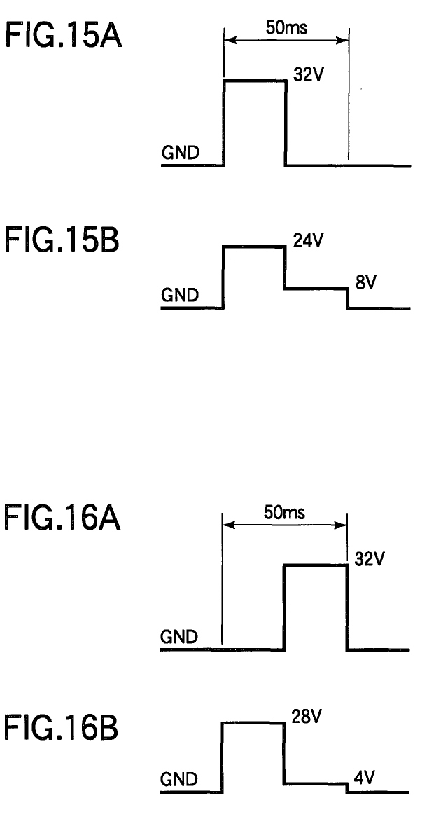

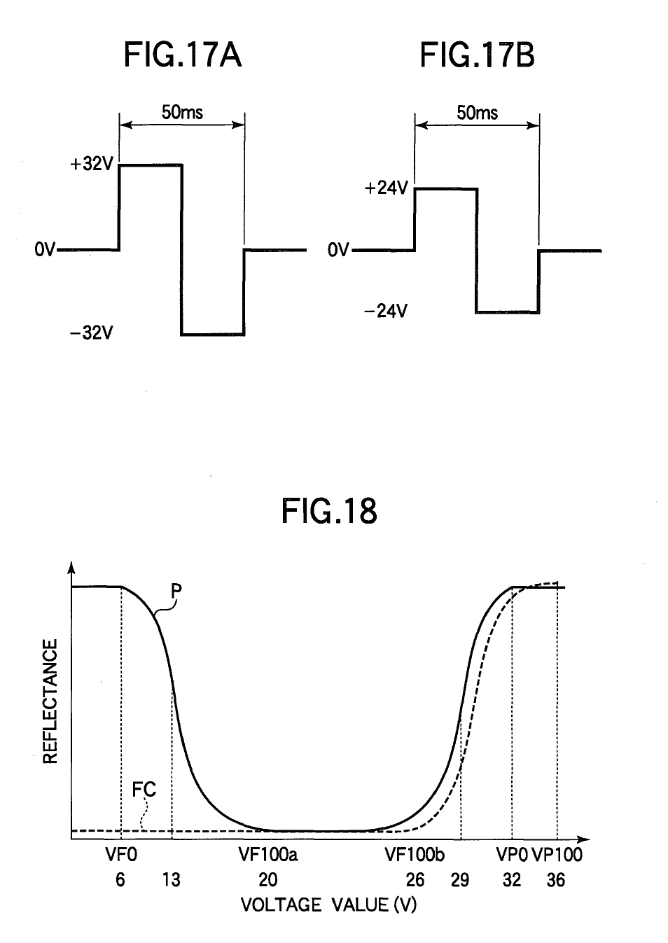

A method of driving the liquid crystal display element of the present embodiment will now be described. FIG. 15A shows a voltage waveform applied for one selection period from the data side driver IC 20 to a signal electrode 50 to put the liquid crystal in the planar state based on drive data input from the data control portion 26. The duration of the selection period is substantially in the range from several ms to several tens ms (e.g., 50 ms), although the duration depends on the liquid crystal material and element structure employed. In general, the response of a liquid crystal layer to a voltage is slower, the lower the temperature thereof. Therefore, a longer selection period is preferred, the lower the temperature. It is also preferable to change the selection time according to the dividing width for the temperatures T used in the image correction LUT. FIG. 15B shows a voltage waveform applied from the data side driver IC 20 to a signal electrode 50 to put the liquid crystal in the focal conic state. FIG. 16A shows a voltage waveform applied from the scan side driver IC 20 to a selected scan electrode 48, and FIG. 16B shows a voltage waveform applied from the scan side driver IC 20 to an unselected scan electrode 48. FIG. 17A shows a voltage waveform applied to the liquid crystal layer 46 at a pixel to be driven into the planar state, and FIG. 17B shows a voltage waveform applied to the liquid crystal layer 46 at a pixel to be driven into the focal conic state.

FIG. 18 is a graph showing an example of voltage-reflectance characteristics of cholesteric liquid crystals. The abscissa axis represents voltages (V) applied to liquid crystal layers 46, and the ordinate axis represents reflectances of the liquid crystal layers 46 observed after the application of the voltages. The state in which the liquid crystal layers 46 have relatively high reflectances is the planar state, and the state in which the liquid crystal layers have relatively low reflectances is the focal conic state. The curve P in a solid line shown in FIG. 18 represents voltage-reflectance characteristics of a liquid crystal layer 46 which is initially in the planar state, and the curve FC in a broken line represents voltage-reflectance characteristics of a liquid crystal layer 46 which is initially in the focal conic state.

The signal electrode 50 of a pixel to be driven into the planar state has a voltage of +32 V in the first half of the selection period as shown in FIG. 15A, and the scan electrode 48 of the pixel has a voltage of 0 V as shown in FIG. 16A. As a result, a voltage of +32 V is applied to the liquid crystal layer 46 at that pixel as shown in FIG. 17A. In the second half of the selection period, the voltage at the signal electrode 50 becomes 0 V, and the voltage at the scan electrode 48 becomes +32 V. Then, a voltage of −32 V is applied to the liquid crystal layer 46 at that pixel. Since a voltage applied to the liquid crystal layer 46 in a non-selection period is +4 V at the maximum, a pulse voltage of substantially +32 V is applied to the liquid crystal layer 46 at that pixel in the selection period. When a strong electric field is generated in a liquid crystal layer 46, the helical structure of the liquid crystal molecules is completely decomposed, and the liquid crystal enters a homeotropic state in which the directions of the longer axes of all liquid crystal molecules follow the direction of the electric field. When the electric field is abruptly removed from the liquid crystal in the homeotropic state, the helical axis of the liquid crystal becomes perpendicular to electrode surfaces. Thus, the liquid crystal enters the planar state in which light having a wavelength according to the helical pitch is selectively reflected. That is, the liquid crystal layer 46 enters the planar state when the pulse voltage of ±32 V (≈VP0) is applied, and the pixel enters a bright state as shown in FIG. 18.

The signal electrode 50 of a pixel to be driven into the focal conic state has a voltage of +24 V in the first half of the selection period as shown in FIG. 15B, and the scan electrode 48 of the pixel has a voltage of 0 V as shown in FIG. 16A. As a result, a voltage of +24 V is applied to the liquid crystal layer 46 at that pixel as shown in FIG. 17B. In the second half of the selection period, the voltage at the signal electrode 50 becomes +8 V, and the voltage at the scan electrode 48 becomes +32 V. Then, a voltage of −24 V is applied to the liquid crystal layer 46 at that pixel. Since a voltage applied to the liquid crystal layer 46 in a non-selection period is ±4 Vat the maximum, a pulse voltage of substantially ±24 V is applied to the liquid crystal layer 46 at that pixel in the selection period. An electric field having such a relatively low intensity that the helical structure of liquid crystal molecules is not completely decomposed is generated at the liquid crystal layer 46 and is thereafter removed. Alternatively, a strong electric field is generated at the liquid crystal layer 46 and is thereafter slowly removed. Then, the helical axis of the liquid crystal becomes parallel to the electrode surfaces, and the liquid crystal enters the focal conic state in which incident light is transmitted. That is, the liquid crystal layer 46 enters the focal conic state when the pulse voltage of ±24 V (<VF100b) is applied, and the pixel enters a dark state.

Voltages between voltages VF100b (e.g., 26 V) and VP0 (e.g., 32 V) or voltages between voltages VF0 (e.g., 6 V) and VF100a (e.g., 20 V) are used to display intermediate tones. When pulse voltages having such voltage values are applied, the liquid crystal is in a state of alignment which is a mixture of the planar state and the focal conic state and in which intermediate tones can be displayed. The display of intermediate tones using voltages between the voltages VF0 and VF100a is limited in that the liquid crystal must be initially in the planar state. However, the intermediate tones have small display irregularities, and high display quality can be achieved. When intermediate tones are displayed using voltages between the voltages VF100b and VP0, the intermediate tones have somewhat more significant display irregularities, and it is difficult to exercise control to suppress cross-talk using general-purpose driver ICs. However, there is an advantage in that writing can be carried out in a shorter time.

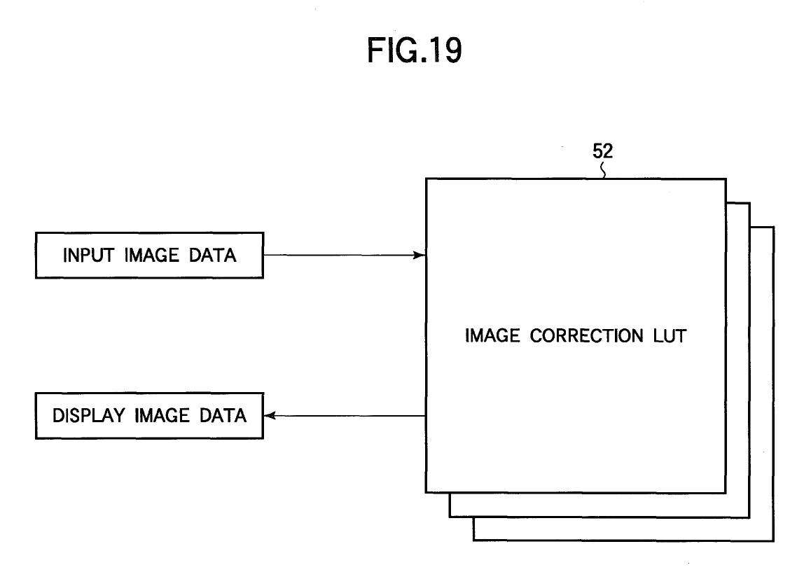

FIG. 19 shows a modification of the image correction LUT. In an image correction LUT 52 of the present modification, display image data associated with input image data and temperatures are directly stored instead of correction coefficients. In this modification, since display image data are directly stored in the image correction LUT 52, the speed of the conversion process for generating the display image data is significantly increased. However, the image correction LUT 52 requires a greater memory capacity. For example, when temperatures are divided into nine temperature ranges in a way similar to that shown in FIG. 14B, 260,000×9 pieces of data must be stored in the image correction LUT 52 to display 64 gray levels of each of red, green, and blue, i.e., 260,000 colors. In this case, correction values may be thinned out when they are stored in the image correction LUT 52, and a data interpolation process may be performed to accommodate the input of intermediate input image data which are not stored in the LUT.

As described above, in the color display element having a multi-layer structure of the present embodiment, the tint of a color displayed in association with input image data can be kept substantially constant without temperature dependency. Therefore, the present embodiment makes it possible to provide a display element which exhibits high display quality without being effected by the environment.

### Second Embodiment

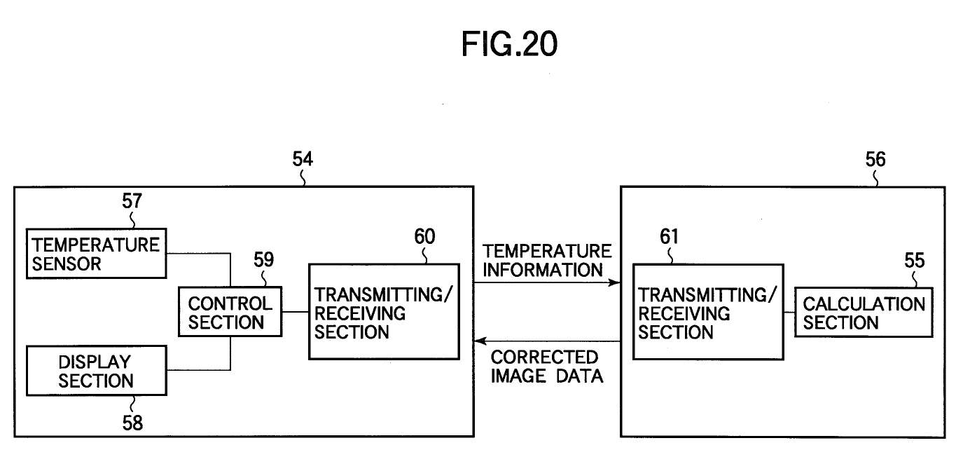

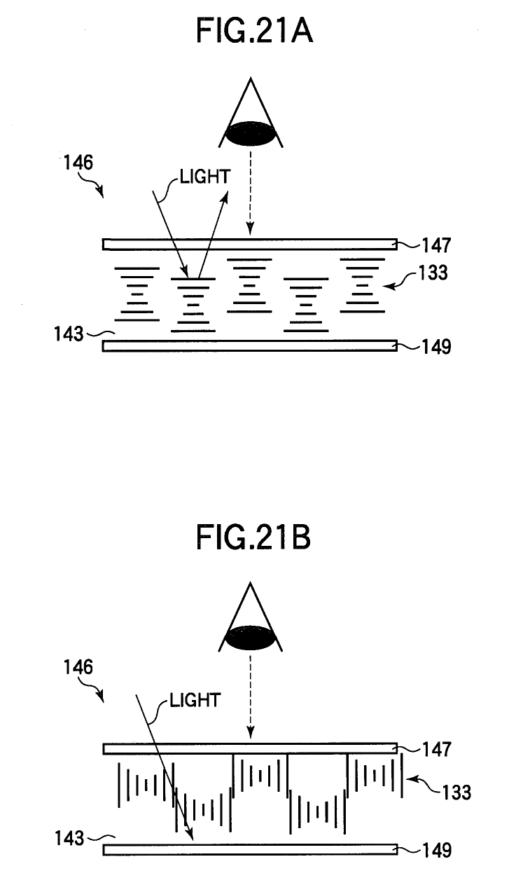

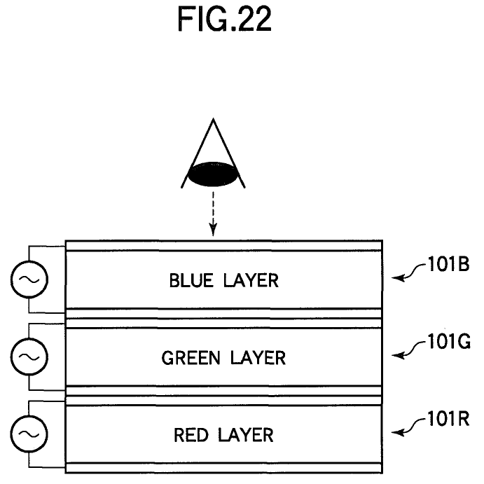

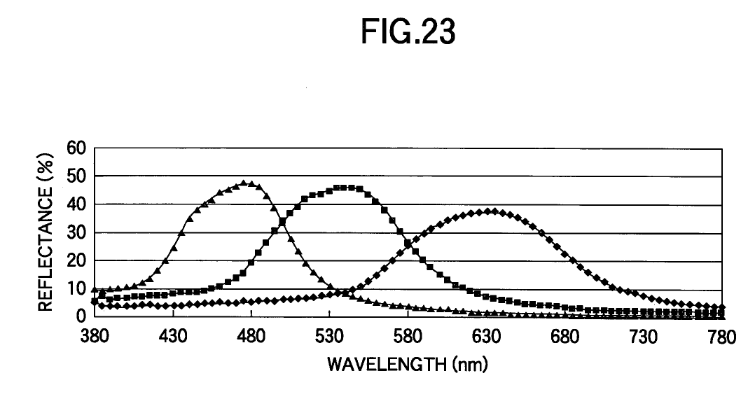

A display system according to a second embodiment of the invention will now be described with reference to FIG. 20. FIG. 20 is a block diagram showing a schematic configuration of a display system according to the present embodiment. As shown in FIG. 20, the display system includes a display element (e.g., electronic paper) 54 and a data server (display information transmission apparatus) 56 transmitting image data to the display element. The display element 54 and the data server 56 are connected on a wireless basis through an interface such as a wireless LAN or Bluetooth (a registered trademark). The connection between the display element 54 and the data server 56 may be a wired connection utilizing an interface such as USB.

The display element 54 includes a display section 58 having a configuration in which a display layer for displaying blue, a display layer for displaying green, and a display layer for displaying red are formed one over another. The display element 54 also includes a temperature sensor 57 for detecting temperature in the vicinity of the display section 58 and a control section 59 like the display element shown in FIG. 12. However, the control section 59 of the display element 54 is different from the control section 29 of the display element shown in FIG. 12 in that it does not include an LUT selector, an image correction LUT, and an image conversion portion. Further, the display element 54 includes a transmitting/receiving portion 60 for transmitting temperature information to the data server 56 and receiving display image data from the data server 56.

The data server 56 has a calculation section (control section) 55 including an LUT selector, an image correction LUT, and an image conversion portion. In the present embodiment, the LUT selector, the image correction LUT, and the image conversion portion are provided at the data server 56 rather than the display element 54. Further, the data server 56 includes a transmitting/receiving section 61 for receiving temperature information from the display element 54 and transmitting display image data to the display element 54.

When the data server 56 attempts to display a predetermined image on the display section 58 of the display element 54, for example, the data server 56 transmits a temperature information request signal to the display element 54. Upon receipt of the temperature information request signal, the display element 54 transmits temperature information acquired using the temperature sensor 57 to the data server 56. Upon receipt of the temperature information, the calculation section 55 of the data server 56 generates display image data by correcting input image data input from outside based on the temperature information using the same method as in the first embodiment and transmits the corrected display image data to the display element 54. Upon receipt of the display image data, the display element 54 inputs the received display image data to driver ICs of the display section 58 along with required driving waveform data to driver each display layer of the display section 58. Thus, a display rewrite is carried out at the display section 58 of the display element 54. The tint of a color displayed on the display section 58 in association with the input image data is kept substantially constant without temperature dependency.

Like the first embodiment, in the color display element having a multi-layer structure of the present embodiment, the tint of a displayed color can be kept substantially constant without temperature dependency. Therefore, the present embodiment makes it possible to provide a display element which exhibits high display quality without being effected by the environment. In the present embodiment, since image conversion is performed at the data server 56, there is no need for providing an LUT selector, an image correction LUT, and an image conversion portion at the display element 54. The present embodiment is therefore advantageous in that the display element 54 can be manufactured at a low cost.

The invention is not limited to the above-described embodiments and may be modified in various ways.

For example, the above embodiments have been described by referring to an exemplary display element having reflection spectra which undergo a wavelength shift toward shorter wavelength at a low temperature. However, the invention is not limited to such embodiments. For example, let us assume that reflection spectra of layers of a liquid crystal display element having a multi-layer structure formed by R, G, and B layers undergo a wavelength shift toward longer wavelengths at a low temperature. Then, display image data is generated with a correction made thereon such that grayscale values displayed by the R layer are reduced at the low temperature. As a result, distortion of gray balance toward red is suppressed at the low temperature.

The above embodiments have been described by referring to an exemplary display element in which display image data are corrected based on temperature in the vicinity of a display section. However, the invention is not limited to such embodiments. For example, driving waveform data including data of a pulse width and a peak value may be corrected based on temperature instead of correcting display image data. When reflection spectra undergo a wavelength shift toward shorter wavelengths at a low temperature, a pulse width or a peak value included in the driving waveform data for the B layer may be reduced at the low temperature. Thus, the same advantages as those of the above-embodiments can be achieved.

The above embodiments have been described by referring to an exemplary color liquid crystal display element having a multi-layer structure utilizing a cholesteric liquid crystal. The invention is not limited to such embodiments and may be applied to other types of display elements having memory characteristics and various types of display elements having a multi-layer structure such as reflective display elements.

The above embodiments have been described by referring to electronic paper by way of example, the invention is not limited to such embodiments and may be applied to various electronic terminals having a display element.

Since the invention prevents a change in the tint of a displayed color attributable to the environment, the invention can be advantageously applied to display elements having a multi-layer structure capable of color display.

What is claimed is:

1. A display element comprising:
a display section having a first display layer exhibiting a first spectrum and a second display layer formed on the first display layer and exhibiting a second spectrum shifted from the first spectrum toward longer wavelength;
a temperature detecting section for detecting a temperature in the vicinity of the display section; and
a control section for generating display image data to be displayed by the first and second display layers based on input image data and the temperature such that the tint of a displayed color associated with the input image data is kept substantially constant without depending on the temperature.

2. The display element according to claim 1, wherein the control section includes a lookup table and in that a correction coefficient for correcting the input image data based on the temperature to generate the display image data is stored in the lookup table.

3. The display element according to claim 1, wherein the control section includes a lookup table, and the input image data and the display image data associated with the temperature are stored in the lookup table.

4. The display element according to claim 2, wherein the temperatures in the lookup table are divided into temperature ranges with a dividing width which becomes smaller, the lower the temperature of interest.

5. The display element according to claim 1, wherein the control section generates the display image data by calculating a function using the input image data and the temperature.

6. The display element according to claim 1, wherein the control section generates the display image data taking an overlapping region between the first and second spectra into account.

7. The display element according to claim 1, wherein an electrical signal is applied to the display layers for a duration which is longer, the lower the temperature.

8. The display element according to claim 7, wherein the duration of the application of the electrical signal is varied depending on the dividing width for the temperatures in the lookup table.

9. The display element according to claim 1, wherein the display section includes a third display layer formed on the first and second display layers and exhibiting a third spectrum shifted from the first spectrum toward longer wavelength and shifted from the second spectrum toward shorter wavelength, and the first, second, and third display layers display blue, red, and green, respectively.

10. The display element according to claim 9, wherein the first, third, and second display layers are formed one over another in the order listed from the side of a display surface of the element.

11. The display element according to claim 9, wherein the first, second, and third display layers have memory characteristics.

12. The display element according to claim 9, wherein the first, second, and third display layers include a liquid crystal which forms a cholesteric phase.

13. The display element according to claim 9, wherein color tints originating from the first, second, and third spectra include a color tint which becomes stronger depending on temperature, and the display image data are generated by the control section such that a display grayscale values corresponding to the color tint becomes relatively smaller than display grayscale values corresponding to the other color tints.

14. The display element according to claim 9, wherein the light rotating direction of the third display layer is different from the light rotating direction of the first and second display layers.

15. An electronic terminal comprising a display element, wherein the display element includes a display section having a first display layer exhibiting a first spectrum and a second display layer formed on the first display layer and exhibiting a second spectrum shifted from the first spectrum toward longer wavelength, a temperature detecting section for detecting a temperature in the vicinity of the display section, and a control section for generating display image data to be displayed by the first and second display layers based on input image data and the temperature such that the tint of a displayed color associated with the input image data is kept substantially constant without depending on the temperature.

16. A display system comprising:
a display element including a display section having a first display layer exhibiting a first spectrum and a second display layer formed on the first display layer and exhibiting a second spectrum shifted from the first spectrum toward longer wavelength, a temperature detecting section for detecting a temperature in the vicinity of the display section, and a transmitting/receiving section for transmitting information of the temperature and receiving display image data to be displayed by the first and second display layers; and
a display information transmission apparatus including a transmitting/receiving section for receiving the information of the temperature from the display element and transmitting the display image data to the display element and a control section for generating the display image data based on input image data and the temperature such that the tint of a displayed color associated with the input image data is kept substantially constant without depending on the temperature.

17. An image processing method comprising the steps of:
detecting a temperature in the vicinity of a display section having a first display layer exhibiting a first spectrum and a second display layer formed on the first display layer and exhibiting a second spectrum shifted from the first spectrum toward longer wavelength; and
generating display image data to be displayed by the first and second display layers based on input image data and the temperature such that the tint of a displayed color associated with the input image data is kept substantially constant without depending on the temperature.
